(19) United States
(12) Patent Application Publication
(10) Pub. No.: US 2026/0103825 A1
(43) Pub. Date: Apr. 16, 2026

(54) SOLUTION DYED YARN COLOR CORRECTION

(71) Applicant: Aladdin Manufacturing Corporation, Calhoun, GA (US)

(72) Inventor: Anthony Cascio, Calhoun, GA (US)

(73) Assignee: Aladdin Manufacturing Corporation, Calhoun, GA (US)

(21) Appl. No.: 19/112,927

(22) PCT Filed: Sep. 11, 2023
(86) PCT No.: PCT/IB2023/058978

§ 371 Date: Mar. 18, 2025

Related U.S. Application Data
(60) Provisional application No. 63/376,438, filed on Sep. 21, 2022.

(51) Int. Cl. D01D 1/06; D01F 1/06

(52) U.S. Cl. CPC D01D 1/065; D01F 1/06

(57) ABSTRACT

Various methods of coloring a stream of polymer melt to produce filaments to a desired and consistent color and luster may include adding one or more colorants to the polymer stream at one or more selected locations in the flow of the stream of the polymer melt before entering and through an extruder. The color of the polymer melt and the extruded filaments may be determined by sensors at selected locations within the extruder and after the filaments have been extruded. A comparison of the sensed color to the desired color may be made and corrective actions may be taken if the color deviates from the desired color. The corrective actions may be to discard some of the polymer melt and/or the extruded filaments, or to make changes to the amount of colorant being added at one or more of the locations in the process.

The present inventions relate to a method of coloring a stream of polymer melt to produce filaments to a desired and consistent color and luster. One of many methods of obtaining filaments of a desired and consistent color using the inventions disclosed herein may be to add one or more colorants to the polymer stream at one or more selected locations in the flow of the stream of the polymer melt before entering, and passing through an extruder. The color of the polymer melt and the extruded filaments may be determined by sensors at selected locations within the extruder and after the filaments have been extruded. A comparison of the sensed color to a desired color may be made and corrective actions may be taken if the color deviates from the desired color. The corrective actions may be to discard some of the polymer melt and/or the extruded filaments, or to make changes to the amount of colorant being added to the polymer at one or more of the locations in the process.

### BACKGROUND

Extruded filaments of polymers may be used for making yarn for carpets. When using a feedstock of virgin polymer, the properties of the material—e.g., color, transparency, etc.—will be known and consistent. However, there may be variations in these properties when using recycled polymers. Even with sufficient mixing before entering the extruder, and blending within the extruder, there may still be slight variations of the final yarn produced as the feedstock may have different properties over the duty cycle that an extruder is actively extruding filaments.

However, it is a desire to produce yarn having consistent properties that overcomes the variations in the properties of the feedstock that would otherwise cause some deviations from the desired color.

### BRIEF SUMMARY

To this aim, the invention relates to an apparatus for coloring polymer and a method as defined in the appended independent claims, wherein preferred embodiments are defined in the dependent claims.

In a first independent aspect, the invention relates to an apparatus to change the color of a yarn, comprising: a hopper and an extruder, wherein the hopper is configured to control a rate of flow of a plurality of polymer flakes into the extruder; at least one sensor configured to communicate a signal comprising at least one value of a photonic property of the plurality of polymer flakes; a fluid injector configured to inject a color concentrate into the plurality of polymer flakes; and a processor, wherein the processor is configured to receive the signal and to make at least one adjustment to the fluid injector based on the received signal.

In another independent aspect, the invention relates to an apparatus to produce a yarn having a consistent color, comprising: a hopper and an extruder, wherein the hopper is configured to control a rate of flow of a plurality of polymer flakes into the extruder; at least one sensor configured to communicate a plurality of signals, wherein each signal comprises at least one value of a photonic property of the plurality of polymer flakes, and wherein each value is associated with a time; a fluid injector configured to inject a color concentrate into the plurality of polymer flakes; and a processor configured to receive the plurality of signals and process the values, wherein the processing of the values comprises, storing at least two values with their associated times, averaging the at least two values to produce an average value, and comparing the average value with a default value; and make at least one adjustment to the fluid injector based on the comparison.

In another independent aspect, the invention relates to a method to produce a yarn with a consistent photonic property, comprising: provide a hopper and an extruder, wherein the hopper is configured to control a rate of flow of a polymer feedstock into the extruder; provide at least one sensor configured to communicate a plurality of signals wherein each signal comprises a value of a photonic property of the polymer feedstock; provide a fluid injector configured to inject a flow of color concentrate into the polymer feedstock; provide a processor, wherein the processor is configured to communicate with the hopper, the at least one sensor, and the fluid injector; convey the polymer feedstock into a blender; convey the polymer feedstock from the blender into the hopper; convey the polymer feedstock from the hopper into the extruder, which is configured to grind and melt the polymer feedstock and extrude the polymer feedstock as polymer filaments; communicate the plurality of signals to the processor; process the signals within the processor to: associate a time with each value of the photonic property; average the values to produce an average value; compare the average value with a configured value; and communicate an instruction to the fluid injector to adjust the flow of color concentrate into the polymer feedstock based upon the comparison.

In one of many embodiments of the inventions taught and disclosed herein, color concentrate may be added to a feedstock of polymer prior to the feedstock entering and being processed by an extruder. The color of the polymer melt and/or extruded filaments may be detected by one or more sensors within the extruder, and/or by a sensor after the polymer is extruded. A controller may correlate the sensed color with what will become a final color and may make adjustments to the rate of addition of the color concentrate so that a consistent fiber will be made.

Those familiar with the art will understand that a color concentrate, as used herein, may describe an additive that will color the polymer and carry through to color the extruded filaments. Such additives may be fluids, powders, or may be in a masterbatch format in a polymer carrier. The term color concentrate will be used herein without limitation to describe any or all of these.

The feedstock of polymer may be virgin polymer in any form, or polymer flakes, pellets, or nurdles that have been reclaimed from recycled products such as bottles and/or carpet. An example of recycled products would be polymer flakes from bottles made from polyethylene terephthalate (PET). Even when using high-quality flakes, such as from deposit bottles, there may be some variations in the colors and/or the transparency of the feedstock. These variations are usually exacerbated when curbside bottles are used. This may also be the case when using recycled single-color carpet since portions of the carpet may have stains, or portions may retain adhesive remnants that are a different color than the carpet. Again, the variations may be exacerbated when multicolored carpet is used.

In many described embodiments herein, flakes of polymers may be used as an example of the raw feedstock. However, it will be known to those of ordinary skill in the art that other forms of raw feedstock may be used without departing from the scope and intent of the inventions claimed herein.

In one of many embodiments of the inventions disclosed herein, color concentrates may be added to a blender feeding polymer flakes into an extruder. The blender may be a multi-hopper blender and the color concentrates may be dropped or streamed from an injector into the blender. In one of many embodiments, the color concentrates may be gravity-fed. Alternatively, the color concentrates may be injected into the mixture of polymer flakes at other points in the flow of feed to the blender and/or the extruder.

In one of many embodiments, the injector may have a set of standard colors that may be mixed to produce colors within a predetermined spectrum. In one embodiment, the spectrum may be the entire visible range. In another embodiment, the colors may be selected to produce final products within a specific portion of the visible range, such as a red color ranging from a dark pink to a magenta. In some preferred embodiments, the injector may have four colors, or three colors along with black, that may be used to produce colors throughout the visible spectrum.

The injector is controllable by the system controller and capable of precisely measuring an amount of fluid to be injected. In some embodiments, the color concentrate may be injected in an undiluted form. However, in other embodiments, it may be advantageous to dilute the color concentrate before applying it to the polymer flakes. Similarly, it may be advantageous to have a mechanism that performs mixing of the color concentrate with a diluent while applying it to the polymer feed. The diluent may be a solvent that is configured to evaporate within the extruder, or it may comprise components that act to spread the color concentrate to the polymer flakes at rates faster than would be practicable without the components. In one embodiment, a diluent may facilitate the color concentrate being applied in a spray such that the color concentrate does not clog the spray head and averts sputtering. In another embodiment, the injector may be fluidly connected with a fluid that may be used to purge the injector nozzles without adding color to the polymer.

In an envisioned embodiment, one or more color spectrophotometers may be used to determine the color of the raw feedstock before the color concentrates are mixed with the flakes in the blender. The system controller may use this information to make some initial estimates of the amounts of color concentrates that will be needed to produce a yarn with a desired color. Since the raw feedstock is moving rapidly into and through the blender, and since it is unlikely that the flakes will be uniformly arranged, the system controller may be configured to make only small changes to the amounts of color concentrates that will need to be added to the blender. That is to say that even if the color sensor detects a large change of color in the inflow of polymer flakes, the system controller will not make correspondingly large injections of color concentrates, but will rely more upon the input received from color sensors downstream of the extruder feed.

An example of this phase of the process may be that over a first time period, a fairly uniform flow of polymer flakes may be conveyed into the blender. The system controller will use a pre-configured rate to add the color concentrate. Then, during a second time period, the sensors may detect that the feed polymer is of a darker color. To adjust for that, some titanium dioxide (TiO₂), or other components known to those ordinarily skilled in the art, may be added with other color concentrates to lighten the color of the raw feedstock. However, the system controller must be configured to make these predictive changes within some very narrow parameters. In some cases, the color detected by the sensor or sensors may appear to be lighter or darker than they actually are because of an arrangement of the flakes. That is to say that as the flakes are conveyed into the blender, some flakes may stack up more or less to appear to have a darker or lighter color than they would if they were normally dispersed.

In another envisioned embodiment, other types of sensors may be used to determine if there are any changes in the conveyed feedstock that would indicate a perceived color change even if there is no actual change in the feedstock properties. In that case, the system controller may give more weight to the color sensor or sensors determining the color of the feedstock and may make more appropriate changes to the amounts of color concentrates being added.

In a preferred embodiment, the system controller will be able to control the injector such that the color concentrate will be applied at a rate of between 0% and 5 wt % of the polymer flakes. The precision of control of the injection system is preferred to be within 0.05 wt %.

One or more color sensors may be placed within the extruder to detect the color of the feed. In one embodiment the color sensor may be a color spectrophotometer. In other embodiments, the color sensor may be a camera or other devices known to those skilled in the art. The color sensors may communicate the colors that they detect to the system controller, which may then make decisions regarding the amounts of color concentrates to add to the raw feedstock. In one of many possible embodiments, the color sensor may communicate a value of the color it detects to the system controller. In another embodiment, the color sensor may provide the actual image it is receiving to the system controller, in which the system controller may convert that image (or a synopsis of the image) into a value or set of values.

The color sensors may be of any type of sensor that can detect and relay any photonic property. A photonic property may be a color in the visual spectrum. It may also be a frequency in any portion of the light spectrum, including the visually perceived spectrum.

The color sensors may detect the photonic properties through any means known to those ordinarily skilled in the art. In one way, a camera may be configured to receive an image using normal lighting. In another way, a camera or spectrophotometer may be configured to receive an image of the product by way of light shining through the product. Similarly, an ultraviolet spectrophotometer may be configured to receive ultraviolet light from multiple sources shining on and through the product.

The placement of the color sensors within an extruder may have an impact on the weight given to the colors detected. For example, a sensor placed very near to the intake of the extruder may detect a large variance of color as the color additives will only be partially blended with the polymer melt. Similarly, a sensor placed mid-way through an extruder will be able to detect a more accurate color of the polymer melt since more blending has occurred, and a sensor placed at the end of an extruder, e.g., near a point where the polymer blend is about to enter the spinneret, the color detected will be most accurate and representative of the true color of the extruded filaments.

In an extruder that only has a color sensor at the intake of the extruder the system controller would be able to make very rapid adjustments to the amounts of color concentrates being added to the polymer flakes currently going through the blender. However, the color of the resultant filaments would likely not be consistent because of the variations of dispersion of the color concentrated within the polymer feed stream at that point. In an extruder that only has a color sensor at the midpoint, the accuracy would be greater, but there would be a longer lag time between the detection of the color of the melt and any adjustments that a system controller could make. At the other end of these examples, a color sensor near the point of extrusion would provide the most accurate detection of the polymer melt but with a considerable lag time before corrections could be made by the system controller.

In an exemplary extruder having sensors at the intake, the midpoint, and near the exit, a system controller may associate a small weight on the accuracy of the color detected at the intake; a larger weight on the accuracy of the color at the midpoint; and the largest weight on the accuracy of the color near the exit.

The weights used by the system controller in this exemplary extruder need not be statically assigned but may be dynamically adjusted. In one of many embodiments that may be used by those in possession of the inventions disclosed and taught herein, adjustments to each, some, or all of the sensor inputs may be used by the system controller to dynamically change the weights given to the inputs of the color sensors.

As an example, the system controller for an extruder with a single color sensor may time-weight the inputs from the color sensor. In an exemplary embodiment where the single color sensor is located near the intake of the extruder, it may be known that the variations of the color are going to be wide since the color concentrates may be poorly mixed with the polymer melt at that point. However, averaging out the detected color of the polymer melt with the color concentrates over a period of time may provide greater accuracy of the prediction of the resulting yarn. The system controller may receive signals of the color from the color sensor and give a higher weight to the signals received within the past 5 seconds, than the weight given to signals received from the previous 5 seconds. This weighting could then be configured to overlook the minute changes to view the overall consistency of the blend of the color concentrates and the polymer melt. In this way, the system controller would still be able to detect and make adjustments for the changes to the color of the raw feed mixed with the color concentrates. As a non-limiting example, if the system controller determines that the color is becoming too dark, it may add a component to lighten the color, or if the color is becoming too light, the system controller may add a component to darken the color.

The exemplary embodiment of using time-weighted averages from a single color sensor within an extruder may also be applied to using time-weighted averages with multiple color sensors within an extruder to provide even more accuracy to the consistency of the produced filaments and ultimately to the color of the produced yarn.

While the exemplary embodiments disclosed above reference that time may be a factor that influences the weight given by the system controller to the input received from one or more color sensors, the inventions disclosed and taught herein are not limited to a time-based factor. Other factors may be apparent to those ordinarily skilled in the art and in possession of the inventions and teachings disclosed herein without departing from the scope of the claimed inventions. Without limitation, other exemplary factors that may be used to dynamically weight the inputs to the system controller may include: the mass flow of the polymer flakes into and/or through the extruder; the rate of mixing of the polymer flakes in the blender; the amounts of additives being mixed with the color concentrates; and similar factors. Indeed, these factors may be used individually, or in combinations with or without the factor of time to produce a consistent color.

The weighting for the factors may be done through any averaging method, including, but not limited to: a simple moving average; a weighted moving average; an exponentially decaying average; or a modified moving average. The method of averaging may be changed during the process to prevent any predictable oscillation in the process.

In some preferred embodiments, a single method may be continuously used with its parameters changed to avoid oscillation from overcompensation. One, non-limiting example of this embodiment may be where the rate of input of the feedstock is increased but the amount of color concentrate has not yet changed. In this exemplary embodiment, a simple weighted average may be in use in the system such that the most recent interval of 5 seconds have a higher weight than the previous 5 seconds, and a final time period of the previous 5 seconds has the least weight. In this exemplary embodiment, the system controller may use the weighted input of the color sensor (or color sensors) to evaluate the color of the polymer melt once during each second. When the system controller detects that the color is lighter than it should be, the system controller may determine an appropriate rate of injection for the color concentrate and instruct the color concentrate injector to increase the rate of injection of the color concentrate to that rate. When the rate of injection is changed, the system controller may then modify the time periods to three intervals of two seconds with the same weights applied to each interval. Lengthening each of these intervals from one second to two seconds will allow the system to stabilize before the system controller again makes a decision on changing the rate of injection of color concentrates. In this exemplary embodiment, the lengthening of the intervals will place a much higher weight on the average of the most recently detected colors of the polymer melt and no longer evaluate the portions of the polymer melt stream that have already passed the color sensor (or color sensors). That is to say that changing the intervals will allow the system controller to more quickly detect the most recently colored polymer melt going through the extruder and to discount the color of the polymer melt that has already passed the sensor(s).

In other preferred embodiments, these weighting methods may be combined and used at different times in the process to ensure that any changes to the amounts of color concentrates do not produce unwanted effects. In the previously presented exemplary embodiment, the time intervals may be kept the same but the system controller may use an exponentially decaying averaging method on the second and third intervals. Again, the result will be that the system controller will place much greater weight on the color detected of the most recently sensed polymer melt and much less weight on the color detected of the polymer melt that has already gone past the sensor(s).

In yet another embodiment, the weighting method may be kept the same but the weights assigned to each interval may be changed. An example of this may be that the time intervals may be kept the same, but the weights for the second and third intervals may be placed so low that they have a negligible effect on the decision making process. Again, the most recently detected color of the polymer melt will have the highest weight in allowing the system controller to determine if the color of the polymer melt is where it is expected to be, or if any further changes are needed to the rate of injection of the color concentrates.

In another embodiment that exemplifies the scope of the inventions disclosed and taught herein, the rate of injection of the color concentrate may be kept constant but the let down rate of the hopper may be regulated to achieve a consistent end-product color. Similarly, both the rate of injection of the color concentrate and the let down rate of the polymer from the blender may be controlled by the system controller and varied as needed to produce a consistent end product. Those of ordinary skill in the art and in possession of the disclosures and teaching herein will realize that other controls may be utilized to change the flow rate of the polymer going through the apparatus described herein to achieve the desired properties of the final product without departing from the spirit of the inventions disclosed and taught herein.

In another preferred embodiment, a color sensor may be placed downstream of the extruder to measure the color of the extruded filaments. As with the other exemplary embodiments discloses herein, the system controller may weight the input from that color sensor to determine if any adjustments need to be made to the feeds of the polymer source and/or the color concentrates.

Some polymers, such as PET, will blend colors well throughout the extruder even to an extent that a final color may be predicted from color sensors within the extruder, and even within the blender. However, some polymers, such as nylon, do not blend colors as well such that a predictive final color may not be determined well from any single color sensor placed at any location in the process. However, the methods of using multiple sensors and inputs that are averaged as disclosed herein may be used to predict final colors with sufficient accuracy for several purposes.

In another aspect of the inventions taught and disclosed herein, the color sensors within the extruder may be susceptible to a buildup of carbon and/or other materials going through the process. Any buildup of material on the sensor may impede the detection of the correct color of the polymer at that point in the process and may lead to an incorrect color of the final product. While processes may be put in place by the operators of the equipment to periodically clean the sensors, applicants have devised methods of accounting for any buildup of materials to still produce a desired final color. In one exemplary embodiment, a slug of pure polymer melt without any coloring added may be sent through the system and all of the sensors calibrated from this run. In another exemplary embodiment, the processor may apply corrections to the inputs received from the sensors during production based upon the color of the final product. That is to say that the controller may be configured to apply error detecting and correcting algorithms to the inputs and averages of the sensors based upon the sensed inputs, their averages, and the color of the final product. While a color sensor at the end of the process may be used as the sensor determining the color of the final product, it may be susceptible to a buildup of material on its lens as well. to adjust for that, an outside sensor or camera may take a image of the final product, even after it has been wound or packaged. That image may be transmitted to the system controller to test that the system is detecting the correct color or if any error correction needs to take place.

The processes disclosed and taught herein are also applicable to the startup of a process. The processor may be configured with a desired color of a yarn before any polymer is fed into the blender. The processor may also be configured with a default photonic property of the raw feedstock. When polymer flakes are first fed into the blender, the color sensors will not have any images showing the polymer as it is entering the extruder but may calculate a rate of injection of color concentrates to color the initial run of feedstock to a color that will come close to the desired color. As the colored polymer flakes enter and exit the extruder, the processor will start retaining color values and make further adjustments as the methods of averaging the values are deployed. When the processor does have enough retained values, it will then deploy other averaging methods to compare the actual photonic properties of the melt and yarn to desired properties.

### BRIEF DESCRIPTION OF THE DRAWINGS

With the intention of better showing the characteristics of the invention, herein after as an example without any limitative character, some preferred embodiments are described, with reference to the accompanying drawings, wherein:

FIG. 1 represents a system for producing yarn according to the invention;

FIG. 2 represents the system controller connectivity according to the invention;

FIGS. 3 and 4 represent flow charts of the system according to the invention; and

FIGS. 5 and 6 represents exemplary systems and methods according to the invention.

### DETAILED DESCRIPTION

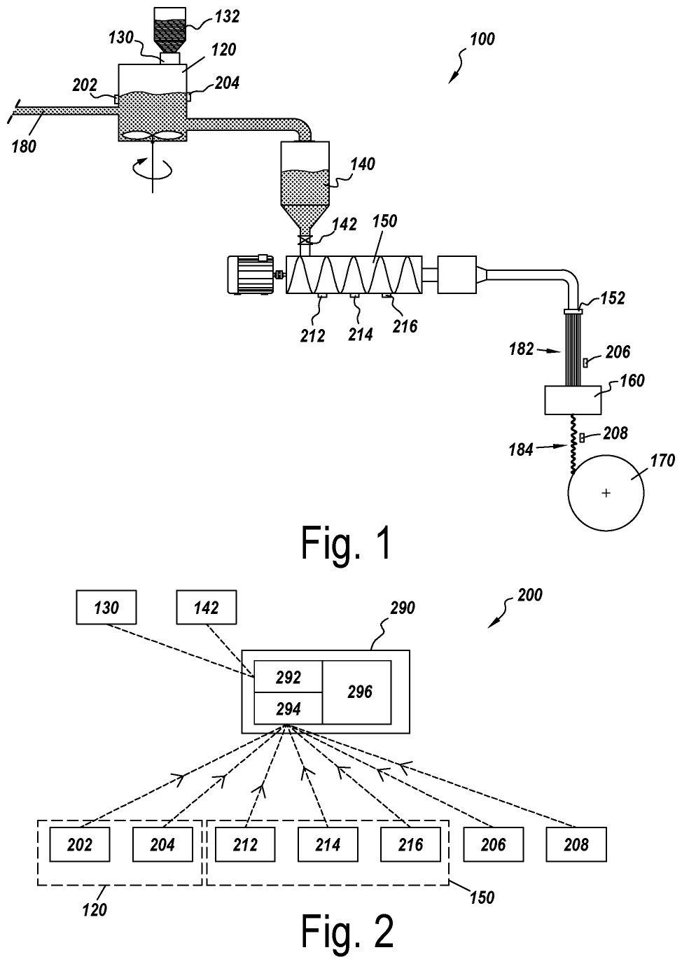

FIG. 1 represents a system 100 for producing yarn according to the invention. The process starts with polymer flakes 180 being conveyed into a blender 120. A color concentrate injector 130 is secured to the blender 120 so that color concentrate may be injected into the blender 120 and mixed with the polymer flakes 180. In this exemplary embodiment, a reservoir 132 of color concentrate may be fluidly connected to the injector 130. In other embodiments, a feed line from an outside source may be connected to the injector 130.

The blender 120 will blend the polymer flakes 180 and will convey them into the hopper 140. In this exemplary embodiment, the hopper 140 is configured with a let down valve 142, which regulates the flow of polymer flakes into the extruder 150. Those of ordinary skill in the art may envision and utilize other means for controlling the flow of the pellets or flakes into the extruder 150, without departing from the spirit of the inventions disclosed and taught herein.

The extruder 150 applies mechanical energy to the polymer flakes 180 to melt and blend them together into at least one polymer melt stream. The polymer melt stream is pumped through a spinneret 152 as filaments 182. The filaments 182 are processed in a post extrusion apparatus 160, which may quench the filaments 182 and process them in ways to produce crimps and twists in individual filaments and then entangle them into a yarn 184, which may be gathered on a godet or roller 170.

Color sensors 202, 204, 212, 214, 216, 206, 208 may be placed throughout the process. Those in possession of this disclosure will understand that the color sensors identified in FIG. 1 are only exemplary and that more or fewer sensors may be utilized in a plethora of embodiments.

FIG. 2 illustrates the system controller 290 and the connectivity to the sensors. In one or many possible embodiments, the system controller 290 comprises a memory 296, a control processor 292 and a sensor input 294. The color sensors 202, 204, 212, 214, 216, 206, 208 are connected to the sensor input 294 of the system controller 296 so that the system controller 296 receives signals from the color sensors 202, 204, 212, 214, 216, 206, 208 that indicate the color they are perceiving. The control processor 292 may activate devices that are connected to it. In the exemplary embodiment, the color concentrate injector 130 and the hopper let down valve 142 may be controlled by the control processor 292.

In FIG. 2, some of the sensors are functionally grouped. Sensors 202, 204 are associated with the blender 120 and sensors 212, 214, 216 are associated with the extruder 150.

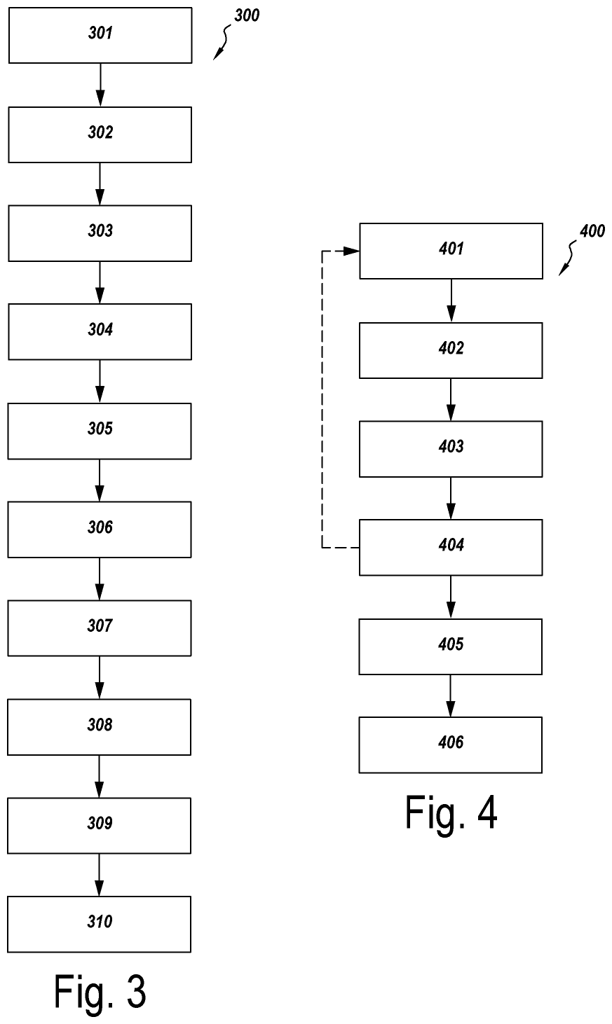

FIGS. 3 and 4 illustrate exemplary flow charts that may be used to provide consistent color to an inconsistently colored inflow of polymer.

The exemplary process 300 illustrated in FIG. 3 may involve the following steps. It must be noted that the process may be a continuous process so that many of the steps may be occurring simultaneously.

Step 301: Convey the raw polymer 180 into the blender 120. The raw polymer may be flakes, pellets, nurdles, or other forms of a polymer. The polymer may be a uniform polymer, such as predominantly PET, or it may be a blend of polymers such as PET and polytrimethylene terephthalate (PTT). The polymer may also consist of recycled polymers such as PET reclaimed from bottles and/or carpet. In some cases, the polymer flakes may comprise flakes of clear polymer and colored polymer where the colors may be light blue, green, black and other colors.

Step 302: Detect the color of the polymer 180 being conveyed into the blender 120 and communicate it to the system controller 290. The color sensor 202 may be positioned such that it may detect the color of the polymer 180 as it enters the blender 120. The color sensor 202 communicates the sensed color to the system controller 290. Ambient light may distort the detection of the true color of the polymer 180. Those sufficiently skilled in the art will know that more consistent results may be obtained by providing a consistent light source placed at an appropriate location such that the color sensor 202 will be able to detect and convey a true color of the polymer 180 to the system controller 290.

Step 303: Add a color concentrate to the polymer flakes 180 in the blender 120. When the system controller 290 determines that the color of the polymer flakes 180 is not at a desired color, the color concentrate may be added by the color concentrate injector 130 at a specific rate.

Step 304: Detect the color of the polymer 180 being blended in the blender 120 and communicate that to the system controller 290. As the polymer flakes 180 are being blended, a color sensor 204 detects the color within the blender 120 and communicates that to the system controller 290. Again, a light source and appropriate location of the color sensor 204 may be utilized to obtain a true color of the blend of polymer flakes 180 in the blender 120.

Step 305: Convey the blended polymer flakes 180 into the hopper 140. The let down valve 142 may be activated to allow more or less of the blended polymer flakes into the extruder 150. When the system controller 290 determines that the color of the polymer flakes 180 is at a desired color, the let down valve will be operated to allow a specific rate of polymer flakes to enter the extruder 150.

Step 306: Grind and process the polymer flakes 180 through the extruder while detecting the color of the polymer melt with color sensors 212, 214, 216 and communicating the detected color to the system controller 290. Color sensors 212, 214, 216 may be placed along the screw paths to detect the color of the polymer melt as it progresses through the extruder 150. Each of the color sensors 212, 214, 216 will communicate the colors that they detect to the system controller 290. In many cases extruders 150 have covers and/or hatches that may be opened or removed so an operator may visually inspect the flow of the polymer melt processing through the extruder 150. Those of ordinary skill in the art will know how to place light sources and the sensors 212, 214, 216 within the extruder to either eliminate light coming through an open cover or hatch, or to disregard or compensate for the ambient light that may detrimentally effect the sensed color.

Step 307: Convey the polymer melt out of the extruder 150 through a spinneret 152.

Step 308: Convey the filaments 182 from the spinneret 152 into a fiber processing unit 160 and detect the color of the filaments 182 and communicate that to the system controller 290. The color sensor 206 may be positioned to detect the color of the filaments 182 as they descend from the spinneret 152. Those ordinarily skilled in the art will know how to arrange a light source with the color sensor 206 to obtain a true color of the filaments 182. Compensation of the detection system will have to be made to account for different filament types since cross-sections of different types of filaments (core/sheath, trilobal, etc.) may dispel light differently. Similarly, some arrangement will need to be made if the filaments 182 are treated with air entanglement soon after being extruded from the spinneret 152. In some embodiments, the filaments 182 may reflect the ambient light into the sensor 206. In other embodiments, the sensor 206 may be placed in a light-proof enclosure along with the stream of filaments 182. In this embodiment, a light source may be positioned in the enclosure so that some of the emitted light is reflected by the filaments 182 into the sensor 206. The system controller 290 may be configured to anticipate and account for any lateral movement of the filaments 182 from any entanglement and drawing processes below the filaments 182.

Step 309: The filaments 182 are processed into yarn 184 and the color of the yarn is detected and communicated to the system controller 290. A light source and appropriate location of the color sensor 208 may be utilized to obtain a true color of the yarn 184.

In some embodiments, the yarn 184 and the sensor 208 may be enclosed within a light-proof enclosure to prevent ambient light from shining upon the yarn 184 and providing a misleading color to the sensor 208.

Step 310: The yarn 184 is wound onto a godet or roller 17. The process of winding or rolling the yarn 184 may move the yarn 184 laterally across the field of view of the sensor 208 in Step 309. The system controller 290 may be configured to adjust for that by accepting more frequent input signals from the sensor 208 within a time period and only using those that are the closest match to the expected color of the yarn 184. This process may be used to remove sensor readings that are taken when the stream of the yarn 184 is not directly centered over the aperture of the sensor 208 and to account for a yarn 184 that has an inconsistent thickness, or has twists and compressions along its length such that it would not present a consistent image to the sensor 208.

In an envisioned embodiment, the position of the stream of the yarn may be detected by means that detect the relative position of the yarn with respect to the aperture of the sensor, such as with LIDAR sensors. The system controller may then select a reading from the sensor to use in its processing when the yarn is at a location that will provide a sensor reading that is the most accurate of the actual color of the yarn.

As will be known to those in the industry, yarns may be constructed of entangled strands of filaments of which each strand may have different photonic properties such as a color. That is to say that a first extruder may be producing filaments of a first color, a second extruder producing filaments of a second color, and a third extruder producing filaments of a third color. In an envisioned embodiment, multiple sensors may be arrayed to sense the image of the yarn composed of multiple photonic properties, such as the colors of each of the filaments.

In one exemplary embodiment, the array of sensors may be located such that the yarn passes across each of them. Using an exemplary yarn of three colors, the first sensor may be configured to sense a color within a limited spectrum associated with that color, the second sensor configured to sense a color within a limited spectrum associated with the second color, and the third sensor configured to sense the third color within a limited spectrum range. As the yarn is assembled from the three groups of filaments, the twists and crimps along with the processing from the godets and reels may not allow each sensor to receive the best image of the color it is configured to receive from the yarn. Again, in such a case, the system controller may be configured to accept a large number of images from each of the sensors in the array and to choose an image that is most likely to be representative of the color it is configured to detect. That chosen image may then be selected as the image to use in the processing described and disclosed herein for the image associated with a single time interval. That is to say that if the system controller is operating to use one image from a sensor (or, in this case, an array of sensors) per every 3 seconds, it may receive 50 images from the sensor or array of sensors within that three second interval and select one image that is most representative of the color it is configured to detect from those 50 images. That one image will then be associated with that time interval and used in the processing disclosed and taught herein.

The exemplary process 400 illustrated in FIG. 4 may involve the following steps. It must be noted that the process may be a continuous process so that many of the steps may be occurring simultaneously.

Step 401: System controller 290 receives communications from each of the color sensors 202, 204, 212, 214, 216, 206, 208. The system controller 290 retains a number of these communications in its memory 296 for processing. Each communication from each color sensor 202, 204, 212, 214, 216, 206, 208 is a color associated with that particular sensor 202, 204, 212, 214, 216, 206, 208. That is to say that a color determined by the color sensor 208 associated with the yarn 184 is received by the system controller 290, the color is retained in the system memory 296 and it is associated with the color sensor 208 associated with the yarn 184.

Step 402: The system controller 290 weight averages the retained colors associated with each color sensor 202, 204, 212, 214, 216, 206, 208. A non-limiting example of this step may start with the color sensor 208 associated with the yarn 184 having sent one color value per second to the system controller 290. The system memory 290 may have the latest and the prior 9 values stored. The system controller 290 may assign a weight of 30% to the latest value, weights of 10% to the prior three values, and weights of 5% to the previously received values. This process would produce a weighted average value for the color detected by the color sensor 208 associated with the yarn 184.

Step 403: The system controller 290 weight averages the weighted average values associated with each of the color sensors 202, 204, 212, 214, 216, 206, 208. While each of the color sensors 202, 204, 212, 214, 216, 206, 208 has an associated weighted average value, the system controller will evaluate these together with previously established weights. Continuing the non-limiting example from step 402, the weighted average value associated with the yarn 184 may be given a weight of 80% and the weighted average value associated with the filaments 182 may be given a weight of 10%, with the weights of all other weighted average values associated with the other color sensors 202, 204, 212, 214, 216 having weights of 2%. The resulting cumulative weighted average value will be predominantly based upon the color of the yarn 184.

Step 404: Compare the cumulative weighted average value with a value of the desired color and determine if correction is needed. Continuing the non-limiting example of the previous steps, the system controller 290 may compare the cumulative weighted average value with the value that is expected for the color of the yarn 184. If the two values are within a defined tolerance, then the system controller will return to step 401 and repeat the process loop. However, if the comparison of the two values is outside of the defined tolerance then corrective action will need to be taken and the process continues to step 405.

Step 405: Determine and apply the corrective action to be taken and change the method to determine the cumulative weighted average value. Continuing the non-limiting example of the previous steps, the system controller 290 may determine that the actual color of the yarn 184 is too light. The system controller 290 may then communication instructions to the color concentrate injector 130 to increase the amount of color concentrate being added to the blender. The system controller 290 may also communicate instructions to the hopper let down valve 142 to reduce the amount of polymer flakes 180 being allowed into the extruder 150. These two actions will increase the amount of colored polymer flakes 180 being introduced into the hopper for a time to allow the color concentrate to fully permeate the hopper 140. After a short time, the system controller may communicate instructions to the hopper let down valve 142 to resume normal flow to the extruder 150. Simultaneous to these actions being taken, the system controller may change the weightings associated with each of the color sensors 202, 204, 212, 214, 216, 206, 208, and may change the weightings used in determining the cumulative weighted average value. In this non-limiting example, the system controller 290 may use a weight of 40% with the color sensor 216 located nearest to the end of the extruder 150, weights of 20% with the color sensors 212, 214 at the front and middle of the extruder 150, 5% for each of the color sensors 202, 204 associated with the blender 120, and 5% for the color sensors 206, 208 associated with the process flow after extrusion from the spinneret 152. Along with this, the system controller 290 may change the time periods associated with sampling the color sensors 206, 208 associated with the process flow after extrusion from the spinneret 152 from once a second to one every three seconds. These changes shift the cumulative weighted average value from the tail-end of the process, which is further away from the upstream changes to a point that is closer to the source of the injection of the color concentrate.

Step 406: Monitor the corrective action. The system controller 290 may continue monitoring the cumulative weighted average value until is aligns with the expected color value. At some time after that, the system controller 290 may revert back to the times and weights for determining the cumulative weighted average value that it had been using prior to Step 405. This again shifts the determination of the cumulative weighted average value to the produced yarn 184. The time to make this reversion will depend upon the flow rate of the polymer through the entire system 100. That is to say that the system controller 290 should not make that reversion while the incorrectly colored yarn 184 is still detectable but should wait for the correctly colored polymer to be extruded through the spinneret 152 and pass through the post extrusion apparatus 160.

### EXAMPLE 1

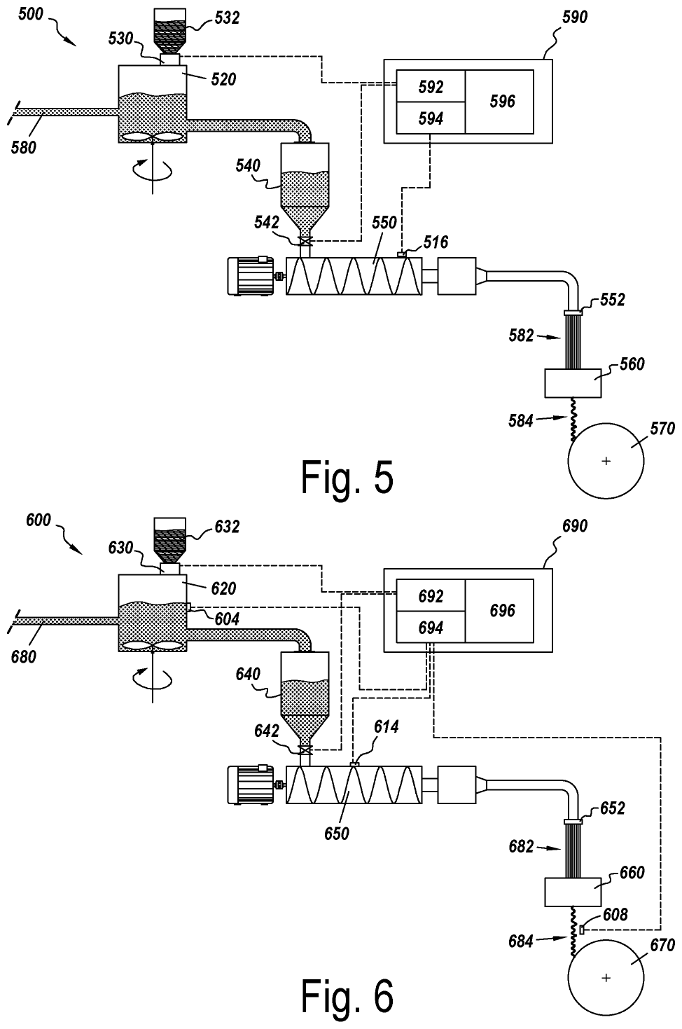

A non-limiting example may be given with reference to FIG. 5. System 500 processes and colors the polymer flakes 580 in the same way as described for system 100 of FIG. 1, but with only a single color sensor 516, which is located at the end of the extruder 550. The sensor 590 communicates a color value to the system controller 590 once every second and the system memory 596 retains 10 values. The cumulative weighted average value is determined using a weighting of 37% for the most recently received color value and 7% weight given to the prior 9 values. A tolerance may be set such that even if the two most recently received values are too light, no corrective actions will be taken.

The color concentrate injector 530 is loaded with a three color concentrates and is controlled by the control processor 592, which also controls the hopper let down valve 542.

In this example, it is desired that the yarn 584 be a specific color. The polymer flakes 580 are mostly from ground carpet, which mostly has a neutral color, but has some other colored portions mixed in.

When the polymer flakes 580 are blended in the blender 520, the blended polymer usually has a consistent neutral color which may be colored to a desired color by adding portions of the three color concentrates. With a consistent run of neutral colored carpet, the three color concentrates are added at a rate and in a proportion to color the polymer flakes 580 so that the resulting yarn 584 is the desired color. However, if some non-neutral colored flakes enter into the system, the resultant color will be affected. This may be altered back to the desired color by making adjustments to the proportions and rates of the color concentrates that are added in the blender 520.

At some time during the process, if a large amount of non-neutral colored polymer flakes are conveyed into the blender 520, and then through the hopper 540 and into the extruder 550, the system controller 590 will detect that from the values sent by the color sensor 516. The system controller 590 may take corrective action by instructing the color concentrate injector to inject a different proportion of the color concentrates into the blender 520 thereby altering the color of the incoming polymer flakes 580 such that the flakes and the new color concentrates will produce a yarn 584 of the desired color. The system controller 590 will also constrict the hopper let down valve 542 until a sufficient amount of more appropriately colored polymer flakes is in the hopper 540. Upon releasing the hopper let down valve 542, the correctly colored polymer flakes will enter the extruder 550 and will be ground and melted and will ultimately pass by the color sensor 516.

Simultaneous with the corrective action being started, the system controller 590 will change the amount of time to receive a value from color sensor 516 from once per second to once per 10 seconds, and will change the weighting of the values to 10% for the current and each of the 9 stored values.

These actions and changes will allow the non-neutral colored polymer melt to go through the extruder 550 so that the color of the polymer melt, and thus the yarn 584, is at a desired color. When the cumulative weighted average value is again within the tolerance of the expected color, the corrective actions will stop and the system controller will reestablish the original timing and weighting. This is expected to allow the portions of the non-neutral colored feedstock to be appropriately colored and pass through the system so that naturally neutral feedstock no longer needs corrective coloring.

### EXAMPLE 2

Another non-limiting example may be given with reference to FIG. 6. System 600 processes and colors the polymer flakes 680 in the same way as described for system 100 of FIG. 1, but with two color sensors 604, 614, which are located in the blender 620 and in the middle of the extruder 650. Additionally, a color sensor 608 is located to provide an x-ray analysis of the yarn 684. The color sensor 608 may be a spectrophotometer configured to operate at a wavelength to provide an analysis of the yarn 684 to determine its luster.

The color sensors 604, 614 communicate their respective sensed color values to the system controller 690 once every second and the system memory 696 retains 10 values for each. The cumulative weighted average value is determined using a weighting of 37% for the most recently received color value and 7% weight given to the prior 9 values for each with a weight of 70% given to the color sensor 614 in the extruder 650, and 30% given to the color sensor 604 in the blender 620. A tolerance may be set such that even if the two most recently received values are too light, no corrective actions will be taken.

The color concentrate injector 630 is loaded with a one color concentrate and is controlled by the control processor 692, which also controls the hopper let down valve 642.

In this example, it may be desired that the yarn 684 be a specific darkness. The polymer flakes 680 are mostly from ground PET bottles, which mostly has a clear or light blue color, but has some other colored portions sporadically mixed in.

When the polymer flakes 680 are blended in the blender 620, the blended polymer usually has a consistent clear or light blue color which may be darkened to a desired shade by adding a black color concentrate. With a consistent run of neutral colored flakes, the color concentrate is added at a rate that will appropriately darken the flakes so that a consistently dark yarn 684 is produced. However, if a large batch of clear flakes enter into the system, the resultant color will be affected. This may be altered back to the desired dark shade by making adjustments to the proportion and rates of the color concentrate that is added in the blender 620.

At some time during the process, if a large amount of colored polymer flakes is conveyed into the blender 620, and then through the hopper 640 and into the extruder 650, the system controller 690 will detect that from the values sent by the color sensors 604, 614. The system controller 690 may take corrective action by instructing the color concentrate injector to inject more of the color concentrate into the blender 620 thereby altering the color of the incoming polymer flakes 680 such that the flakes and the new color concentrates will produce a yarn 684 of the desired darkness. The system controller 690 will also constrict the hopper let down valve 642 until a sufficient amount of more appropriately colored polymer flakes is in the hopper 640. Upon releasing the hopper let down valve 642, the correctly colored polymer flakes will enter the extruder 650 and will be ground and melted and will ultimately pass by the color sensors 604, 614.

Simultaneous with the corrective action being started, the system controller 690 may change the amount of time to receive values from the color sensors 604, 614 and will change the weighting of the values for each color sensor 604, 614. It will also make changes to the relative weights given to the color sensors to place a much higher weight on the values received from the color sensor 614 in the extruder 650.

These actions and changes will allow the clear polymer melt to be colored and go through the extruder 650 so that the darkness of the polymer melt, and thus the yarn 684, is at a desired shade. When the cumulative weighted average value is again within the tolerance of the expected color, the corrective actions will stop, and the system controller will reestablish the original timing and weighting. This is expected to allow the portions of the clear feedstock to be appropriately darkened and pass through the system so that the feedstock no longer needs corrective coloring.

In addition to this process, spectrophotometer 608 may be performing an x-ray analysis of the yarn 684 to determine its luster. Similar to the other examples given, the sensor 608 provides values to the system controller 690. These may be at specific time intervals different from the time intervals for the color sensors 604, 614. The method of averaging the values from the spectrophotometer 608 may also be different from the averaging method used with the color sensors 604, 614.

If the luster of the resulting yarn 684 is determined to be below a predetermined level, the system controller 690 may instruct the injector 630 to add TiO₂. When this occurs, the system controller 690 may receive values from the spectrophotometer at later intervals and with weights designed to allow the passage of the insufficiently lustrous polymer melt and filaments 682 to pass the spectrophotometer 608 before again accepting values from the spectrophotometer 608 to determine of any additional corrective actions need to be taken.

It may be noted in this portion of this example, that the control processor 692 did not activate the let down valve 642 in the hopper 640.

The present invention is in no way limited to the herein above-described embodiments, on the contrary many such floor panels and methods be realized according to various variants, without leaving the scope of the present invention. Claims.

1-41. (canceled)

42. An apparatus to change the color of a yarn, comprising:
a hopper and an extruder, wherein the hopper is configured to control a rate of flow of a plurality of polymer flakes into the extruder;
at least one sensor configured to communicate a signal comprising at least one value of a photonic property of the plurality of polymer flakes;
a fluid injector configured to inject a color concentrate into the plurality of polymer flakes; and
a processor, wherein the processor is configured to receive the signal and to make at least one adjustment to the fluid injector based on the received signal.

43. The apparatus according to claim 42, wherein the processor is configured to make at least one adjustment to the rate of flow of the plurality of polymer flakes based on the received signal.

44. The apparatus according to claim 43, wherein the processor is configured to make at least one adjustment to the fluid injector based on the received signal.

45. The apparatus according to claim wherein the photonic property is a color.

46. The apparatus according to claim 45, wherein the processor retains at least a first value of the photonic property from the at least one sensor.

47. The apparatus according to claim 46, wherein the processor compares the at least first value of the photonic property to a desired value.

48. The apparatus according to claim 47, wherein the processor retains at least a second value of the photonic property from the at least one sensor.

49. The apparatus according to claim 48, wherein the processor assigns weights to the at least first and second values of the photonic property.

50. The apparatus according to claim 49, wherein the processor averages the first and second values with the assigned weights.

51. The apparatus according to claim 50, wherein the processor is configured to adjust a rate of flow of the plurality of polymer flakes in the hopper.

52. An apparatus to produce a yarn having a consistent color, comprising:
a hopper and an extruder, wherein the hopper is configured to control a rate of flow of a plurality of polymer flakes into the extruder;
at least one sensor configured to communicate a plurality of signals, wherein each signal comprises at least one value of a photonic property of the plurality of polymer flakes, and wherein each value is associated with a time;
a fluid injector configured to inject a color concentrate into the plurality of polymer flakes; and
a processor configured to receive the plurality of signals and process the values, wherein the processing of the values comprises,
storing at least two values with their associated times,
averaging the at least two values to produce an average value, and
comparing the average value with a default value; and
make at least one adjustment to the fluid injector based on the comparison.

53. The apparatus according to claim 52, wherein the processor is further configured to associate a weight with each value.

54. The apparatus according to claim 53, wherein each weight is associated with the time associated with each value.

55. The apparatus according to claim 54, wherein averaging comprises weighted averaging.

56. The apparatus according to claim 55, wherein the photonic property is color.

57. The apparatus according to claim 56, wherein the sensor is selected from the group consisting of a camera and a spectrophotometer.

58. The apparatus according to claim 57, wherein the default value is a photonic property of the yarn.

59. The apparatus according to claim 58, wherein the processor is configured to adjust a rate of flow of the plurality of polymer flakes in the hopper based on the comparison.

60. The apparatus according to claim 59, wherein a second sensor is configured to communicate a second plurality of signals, wherein each second signal comprises at least one value of a photonic property of the plurality of polymer flakes, and wherein each second value is associated with a time.

61. The apparatus according to claim 60, wherein the step of processing the second values comprises associating a second weight with each second value.

62. The apparatus according to claim 61, wherein each second weight is associated with the time associated with each second value.
